(19) United States
(12) Patent Application Publication
(10) Pub. No.: US 2013/0111057 A1
(43) Pub. Date: May 2, 2013

(54) NODE DEVICE FOR RELAYING STREAMING CONTENT AND METHOD USING THE SAME

(71) Applicants: Seung-Hyun YOON, Daejeon-si (KR); Tae-Yeon KIM, Daejeon-si (KR); Ho-Young SONG, Daejeon-si (KR)

(72) Inventors: Seung-Hyun YOON, Daejeon-si (KR); Tae-Yeon KIM, Daejeon-si (KR); Ho-Young SONG, Daejeon-si (KR)

(73) Assignee: Electronics and Telecommunications Research Institute, Daejeon-si (KR)

(21) Appl. No.: 13/584,222

(22) Filed: Aug. 13, 2012

(30) Foreign Application Priority Data
Nov. 1, 2011 (KR) 10-2011-0113033

(51) Int. Cl. G06F 15/16

(52) U.S. Cl. 709/231

(57) ABSTRACT

A streaming content relaying apparatus and a method using the same are provided. The streaming content relaying apparatus according to an embodiment of the present invention inspects content characteristics and a network state from content provided from a streaming server, selects one of a unicast transmission scheme and a multicast transmission scheme in accordance with the inspection result, and provides the content streaming services to the user terminal using the selected transmission scheme.

### CROSS-REFERENCE TO RELATED APPLICATION

This application claims the benefit under 35 U.S.C. §119(a) of Korean Patent Application No. 10-2011-0113033, filed on Nov. 1, 2011, the entire disclosure of which is incorporated herein by reference for all purposes.

### BACKGROUND

1. Field

The following description relates to service technology through a network, and more particularly, to a technology for providing content streaming services.

2. Description of the Related Art

Content streaming services through a network are provided to a user terminal through a unicast transmission scheme or a multicast transmission scheme. In this instance, as a server, a unicast streaming server and a multicast streaming server are respectively installed, and the streaming transmission scheme is fixed as a scheme set in advance.

The unicast transmission scheme is a scheme of individually transmitting content between a server and a user terminal, and is used when users are provided with mutually different content.

In the multicast transmission scheme, when transmitting the same content, copies are created every time branching occurs in a network device without need for individual transmission between ends, thereby reducing server and network load.

In the unicast transmission scheme, when a plurality of users are simultaneously provided with the same content, resources may be ineffectively used.

In addition, when the capacity of the server is deficient due to an increase in the number of users, a plurality of servers should be installed, and an L4 or L7 switch is required to be separately mounted in order to relay the plurality of servers or distribute a load to the plurality of servers. Here, in each of the plurality of servers, a streaming server is required to be installed to be operated.

In consideration of these conditions, it is difficult to selectively use the unicast transmission scheme and the multicast transmission scheme in an effective manner, and when expanding to a large number of servers, management and control complexity increases causing inefficiency. This is because of a current scheme in which a network and a streaming server operate without mutual continuity therebetween.

Meanwhile, in the conventional art, Korean Patent No. 2010-0111834 discloses a technique of deciding between a multicast scheme and a unicast transmission scheme in advance based on transmission state information of a terminal to transmit content.

### SUMMARY

The following description relates to a streaming content relaying apparatus which may selectively use a streaming scheme in accordance with content characteristics and a network state, and a method using the same.

In one general aspect, there is provided a streaming content relaying method of a node device for relaying content of streaming services provided to a user terminal through a streaming server, including: inspecting content characteristics and a network state from content provided from the streaming server; selecting one of a unicast transmission scheme and a multicast transmission scheme in accordance with the inspection result; and providing the content streaming services to the user terminal using the selected transmission scheme.

In this instance, the providing of the content streaming services may include inspecting whether there is redundant transmission of content to the user terminal through the streaming server, and inspecting whether content caching and copying are possible when there is redundant transmission, and inspecting whether multicast conversion of the content is possible when the content caching and copying are possible, multicast-transmitting the content to the user terminal when the multicast conversion is possible, and unicast-transmitting the content to the user terminal when the multicast conversion is impossible.

In another general aspect, there is provided a node device, including: a server connection unit that selects a streaming server based on load balancing when receiving a content streaming request signal from a user terminal, transmits the content streaming request signal to the selected streaming server, and relays streaming content between the user terminal and the streaming server; a content caching and unicast transmission unit that inspects whether there is redundant transmission of content to the user terminal, performs content caching and copying when there is redundant transmission, and unicast-transmits the content of the redundant transmission to the user terminal; and a multicast conversion unit that inspects whether multicast conversion of the cached and copied content is possible, and multicast-transmits the content to the user terminal when the multicast conversion is possible.

Other features and aspects will be apparent from the following detailed description, the drawings, and the claims.

### BRIEF DESCRIPTION OF THE DRAWINGS

FIG. 1 is a configuration diagram illustrating a content streaming system according to an embodiment of the present invention; and

FIG. 2 is a flowchart illustrating a streaming content relaying method of a node device according to an embodiment of the present invention.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will suggest themselves to those of ordinary skill in the art. Also, descriptions of well-known functions and constructions may be omitted for increased clarity and conciseness.

Hereinafter, preferred embodiments of the present invention will be described in detail with reference to accompanying drawings.

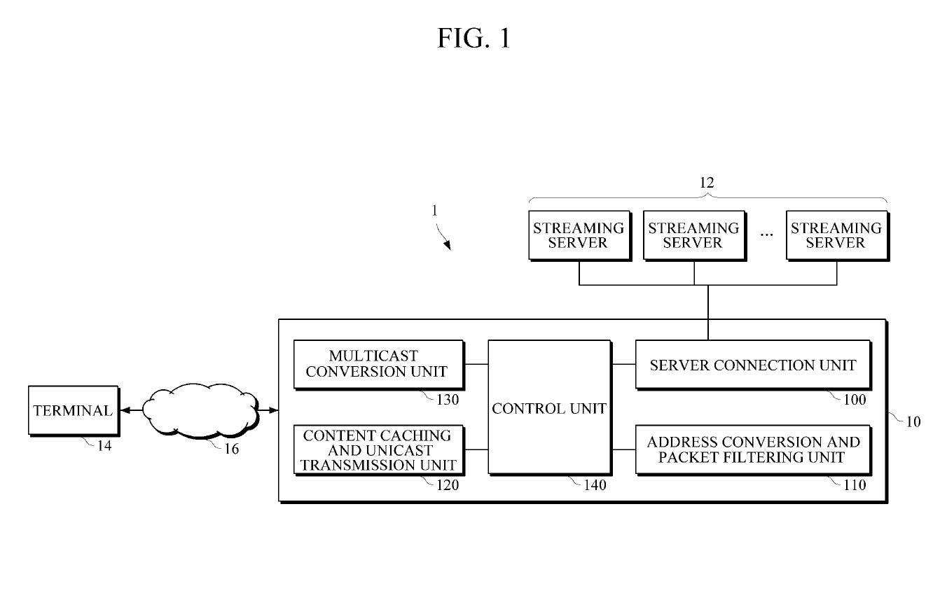

FIG. 1 is a configuration diagram illustrating a content streaming system 1 according to an embodiment of the present invention.

Referring to FIG. 1, the content streaming system 1 includes a streaming server 12 and a node device 10.

The streaming server 12 provides streaming content to a user terminal 14 through the node device 10 using a streaming technique for transmitting content in real time.

In this instance, the streaming server 12 is a combination of a multicast streaming server and a unicast streaming server that are not installed separately but rather composed as a single unit.

When content streaming services are provided in a multicast scheme with respect to predetermined content, the services are provided by a multicast conversion transmission function of the node device 10 not the streaming server 12, and the node device 10 performs all required emulation functions.

The node device 10 relays content of streaming services provided to the user terminal 14 through the streaming server 12. In this instance, the node device 10 is provided with content from the streaming server 12, and inspects content characteristics and a network state.

Next, the node device 10 selects one of a unicast transmission scheme and a multicast transmission scheme and provides the content of the streaming services to the user terminal 14 using the selected transmission scheme. For this, the node device 10 uses its own content copying function and multicast conversion/transmission function.

Specifically, the node device 10 includes a server connection unit 100, a content caching and unicast transmission unit 120, a multicast conversion unit 130, and a control unit 140, and further includes an address conversion and packet filtering unit 110.

The server connection unit 100 selects the streaming server 12 based on load balancing when receiving a content streaming request signal from the user terminal 14.

Next, the server connection unit 100 transmits the content streaming request signal to the selected streaming server 12 and relays the content of the streaming services between the user terminal 14 and the streaming server 12.

The address conversion and packet filtering unit 110 performs IP address conversion (NAT: Network Address Translation) so that the content streaming request signal of the user terminal 14 is transmitted to the streaming server 12, and filters packets received from the streaming server 12.

The content caching and unicast transmission unit 120 inspects whether there is redundant transmission of content to the user terminal 14, performs content caching and copying when there is redundant transmission, and unicast-transmits the content of the redundant transmission to the user terminal 14.

According to an embodiment, for content unicast transmission, the server connection unit 100 selects a main streaming server to provide the content of the redundant transmission to the user terminal 14.

Next, the content caching and unicast transmission unit 120 caches and unicast-copies the content provided through the main streaming server and unicast-transmits the cached and unicast-copied content to the user terminal 14. In this instance, the server connection unit 100 requests streaming service interruption from another streaming server different from the main streaming server.

Next, the multicast conversion unit 130 inspects whether multicast conversion of the content is possible and multicast-transmits the content to the user terminal 14 when the multicast conversion is possible.

According to an embodiment of the present invention, for content multicast transmission, the server connection unit 100 selects a main streaming server to provide the content to the user terminal 14 and sets a multicast channel between the node device 10 and the user terminal 14.

Next, the multicast conversion unit 130 multicast-converts the content provided through the main streaming server and multicast-transmits the multicast-converted content to the user terminal 14. In this instance, the server connection unit 100 requests streaming service interruption from another streaming server different from the main streaming server.

The control unit 140 collectively controls the above-described server connection unit 100, address conversion and packet filtering unit 110, content caching and unicast transmission unit 120, and multicast conversion unit 130.

Meanwhile, a wired/wireless network 16 connects the streaming server 12 and the user terminal 14 in a wired communication network or in a wireless communication network, and provides a wired/wireless communication function so that the user terminal 14 receives multimedia content from the streaming server 12 in real time regardless of via hard line or wireles sly.

Accordingly, as the wired communication network, the Internet, an intranet, or the like may be used, and as the wireless communication network, a mobile communication network or a portable Internet network, or the like may be used, but they are not limited thereto.

The user terminal 14 connects the streaming server 12 through the wired/wireless network 16 and the node device 10 to request multimedia content, and includes a streaming player which receives the multimedia content from the streaming server 12 and plays the received content in real time while storing the received content.

The streaming player may be, for example, Realplayer, Window Media Player, or the like, but is not limited thereto.

In addition, the user terminal 14 may be a mobile communication user terminal such as a PDA (personal digital assistant), a cellular phone, a PCS (personal communication service) phone, a hand-held PC, a GSM (global system for mobile) phone, a wideband CDMA (W-CDMA) phone, a CDMA-2000 phone, an MBS (mobile broadband system) phone, a smart phone, and the like, which support wireless communication, or a notebook, a desktop PC, or the like, which support wired communication, but is not limited thereto.

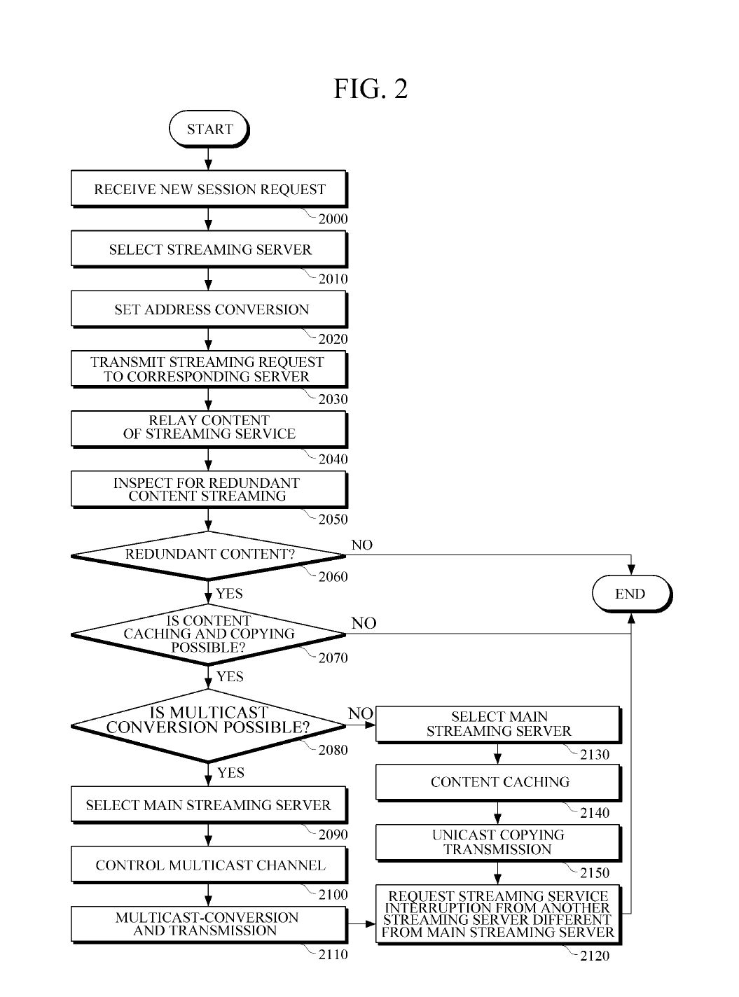

FIG. 2 is a flowchart illustrating a streaming content relaying method of a node device according to an embodiment of the present invention.

Referring to FIGS. 1 and 2, the node device 10 determines whether a new content streaming request signal is received from the user terminal 14.

When the new content streaming request signal is not received from the user terminal 14 based on the determination result, the node device 10 waits until the request is received from the user terminal 14.

In contrast, in operation 2010, the node device 10 selects a predetermined streaming server 12 based on load balancing when the new content streaming request signal is received in operation 2000.

In operation 2020, the node device 10 performs an address conversion setting process so that the content streaming request signal is transmitted to the selected streaming server 12.

Next, in operation 2030, the node device 10 transmits the content streaming request signal to the selected streaming server 12.

In operation 2040, the node device 10 relays content of streaming services between the user terminal 14 and the streaming server 12.

Next, in operation 2050, the node device 10 inspects whether there is redundant transmission of the content transmitted between the streaming server 12 and the user terminal 14.

Next, in operation 2070, when there is redundant transmission of the content, the node device 10 inspects whether a caching and copying transmission function of the node device 10 different from individual streaming is used. Here, when the same content is transmitted with a large time difference, caching and copying may be impossible.

In operation 2080, the node device 10 repeatedly multicast-converts the content of the redundant transmission, and inspects whether transmittable content are present from among the content of the redundant transmission.

In operation 2090, the node device 10 selects a main streaming server when the multicast conversion is possible based on the inspection result in operation 2080.

In operation 2110, the node device 10 multicast-converts the content transmitted through the main streaming server to transmit the multicast-converted content to the user terminal 14.

Next, in operation 2120, the node device 10 requests content streaming service interruption to thereby save server resources. In this instance, operation 2100 of controlling a multicast channel or a connection state of a network may be further performed when multicast-converting and transmitting the content.

Meanwhile, in operation 2130, the node device 10 selects the main streaming server when the multicast conversion is impossible based on the inspection result in operation 2080.

In operation 2140, the node device 10 caches and copies the content transmitted through the main streaming server.

In operation 2150, the node device 10 unicast-transmits the cached and copied content to the user terminal 14.

Thereafter, in operation 2120, the node device 10 requests content streaming service interruption from another streaming server different from the main streaming server to thereby save server resources.

A variety of specific examples of the content caching method, the content copying method, or the multicast conversion method among the above-described processes may be given, and the present invention is not limited by methods of individual functions.

As described above, according to the embodiments of the present invention, the node device may effectively provide content streaming services to a user terminal using content characteristics and a network state. That is, the node device is provided with content from the streaming server, inspects the content characteristics and the network state, selects one of a unicast transmission scheme or a multicast transmission scheme based on the inspection result, and provides the content streaming services to the user terminal using the selected transmission scheme.

In addition, using the content copying function and the multicast conversion transmission function of the node device, it is possible to suppress or prevent growth of servers or a network due to increase in the number of users.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A streaming content relaying method of a node device for relaying content of streaming services provided to a user terminal through a streaming server, comprising:
s inspecting content characteristics and a network state from content provided from the streaming server, selecting one of a unicast transmission scheme and a multicast transmission scheme in accordance with the inspection result and providing the content streaming services to the user terminal using the selected transmission scheme.

2. The streaming content relaying method according to claim 1, wherein the providing of the content streaming services comprises:
inspecting whether there is redundant transmission of content to the user terminal through the streaming server, and inspecting whether content caching and copying are possible when there is redundant transmission, and
inspecting whether multicast conversion of the content is possible when the content caching and copying are possible, multicast-transmitting the content to the user terminal when the multicast conversion is possible, and unicast-transmitting the content to the user terminal when the multicast conversion is impossible.

3. The streaming content relaying method according to claim 2, before the inspecting whether the redundant transmission is performed, further comprising:
selecting the streaming server based on load balancing when receiving a streaming request signal from the user terminal;
transmitting the streaming request signal to the selected streaming server; and
relaying the content of the streaming services between the user terminal and the streaming server.

4. The streaming content relaying method according to claim 2, wherein the inspecting whether the multicast conversion is possible comprises:
selecting a main streaming server to provide the content to the user terminal when the multicast conversion is possible, and setting a multicast channel between the node device and the user terminal;
multicast-converting content provided through the main streaming server, and multicast- transmitting the multicast-converted content to the user terminal; and
requesting streaming service interruption from another streaming server different from the main streaming server.

5. The streaming content relaying method according to claim 2, wherein the inspecting whether the multicast conversion is possible comprises:
selecting a main streaming server to provide the content to the user terminal when the multicast conversion is impossible, caching and unicast-copying content provided through the selected main streaming server, and unicast-transmitting the cached and unicast-copied content to the user terminal; and
requesting streaming service interruption from another streaming server different from the main streaming server.

6. A node device, comprising:
a server connection unit that selects a streaming server based on load balancing when receiving a content streaming request signal from a user terminal, transmits the content streaming request signal to the selected streaming server, and relays streaming content between the user terminal and the streaming server;
a content caching and unicast transmission unit that inspects whether there is redundant transmission of content to the user terminal, performs content caching and copying when there is redundant transmission, and unicast-transmits the content of the redundant transmission to the user terminal; and
a multicast conversion unit that inspects whether multicast conversion of the cached and copied content is possible, and multicast-transmits the content to the user terminal when the multicast conversion is possible.

7. The node device according to claim 6, wherein
the server connection unit selects a main streaming server to provide the content to the user terminal when the multicast conversion is impossible and requests streaming service interruption from another streaming server different from the main streaming server, and
the content caching and unicast transmission unit caches and unicast-copies content provided through the main streaming server, and unicast-transmits the cached and unicast-copied content to the user terminal.

8. The node device according to claim 6, wherein
the server connection unit selects a main streaming server to provide the content to the user terminal when the multicast conversion is possible, sets a multicast channel between the node device and the user terminal, and requests streaming service interruption from another streaming server different from the main streaming server, and
the multicast conversion unit multicast-converts content provided through the main streaming server and multicast-transmits the multicast-converted content to the user terminal.

9. The node device according to claim 6, further comprising:
an address conversion and packet filtering unit that performs IP address conversion so that the content streaming request signal of the user terminal is transmitted to the selected streaming server, and filters packets received from the selected streaming server.
